(19) United States
(12) Patent Application Publication
(10) Pub. No.: US 2024/0155960 A1
(43) Pub. Date: May 16, 2024

(54) WEEDING DEVICE

(71) Applicant: Beyond CenterLine Solutions LLC, Colorado Springs, CO (US)

(72) Inventor: Richard Michael Bond, Colorado Springs, CO (US)

(73) Assignee: Beyond CenterLine Solutions LLC, Colorado Springs, CO (US)

(21) Appl. No.: 18/055,721

(22) Filed: Nov. 15, 2022

(51) Int. Cl. A01B 1/16

(52) U.S. Cl. CPC A01B 1/16

(57) ABSTRACT

A gardening tool is disclosed. The tool may be worn on a user's finger. The tool may include an elongated blade that may include a first blade portion and a second blade portion. A first blade portion distal end may be a sharp end, and a first blade portion proximal end may be attached to a second blade portion distal end via a Z-shaped connector. The tool may further include an elongated tube that may include a tube distal end and a tube proximal end. The tube distal end may be attached to the first blade portion proximal end, and the tube proximal end may be attached to a second blade portion proximal end. The tube may have a tapered shape such that a tube distal end diameter may be smaller than a tube proximal end diameter. Further, the tube may engulf the second blade portion.

### TECHNICAL FIELD

The present disclosure relates to a gardening tool, and more specifically to a gardening implement having features for attaching to a finger for soil penetration and plant matter removal.

### BACKGROUND

People use a variety of gardening tools to manage growth of vegetation around their houses, fields, and lawns. For example, people use trowels, hoes, rakes, shovels, etc. to manage vegetation growth. In addition, some gardening tools are used as weeding tools to remove unwanted weeds, wild grass, dandelions, and crabgrass from lawns. Removal of unwanted weeds and crabgrass may be beneficial for healthy growth of vegetation and for general upkeep of the lawns.

Conventional weeding tools may be bulky and may not be convenient for users to use. For example, some conventional weeding tools may require the users to use both hands and legs to push the tool into the ground and then pull the weed from the ground. Such weeding tools may not be used by users of different physiologies, and hence may have limited usage. Further, the conventional weeding tools may not be convenient for users who may desire to remove weed from small gardens or lawns, where limited space may be available to use bulky weeding tools.

Many gardening enthusiasts have limited hand mobility and may suffer from age-related or other limitations in their hands. Conventional tools may not provide for finger support that allows the user to manipulate soil and plant roots while accommodating limited finger and hand mobility.

Thus, there is a need for a weeding tool that may be convenient for users of different physiologies to use in smaller gardens/lawns.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a backside isometric view of an example gardening tool in accordance with the present disclosure.

FIG. 2 depicts a front side isometric view of the apparatus of FIG. 1 in accordance with the present disclosure.

FIG. 3 depicts an example embodiment of a user using the apparatus of FIG. 1 in accordance with the present disclosure.

FIG. 4 depicts another example gardening tool in accordance with the present disclosure.

### DETAILED DESCRIPTION

### Overview

The present disclosure is directed towards a gardening tool that may be used by a user to remove unwanted plant matter from fields, lawns, etc. Specifically, the gardening tool may be a finger-attachable weeding device or a weeding tool that the user may wear on a finger, e.g., an index finger, and remove weeds or roots from ground. The weeding tool may include an elongated blade and an elongated tube. The blade and the tube may be rigidly or removably connected, and the user may insert the finger into the tube to maneuver the blade and remove the weed/roots from the ground.

The blade may have a blade proximal end and a blade distal end. The blade distal end may be pointed/sharp that may assist the user to remove the weed/roots from the ground. The blade proximal end may be connected to the tube.

In some aspects, the tube may be shaped as a funnel and may be configured to engulf the user finger when the user inserts the finger into the tube. A tube proximal end may be open through which the user may insert the finger into the tube. Further, a tube distal end may be closed, which may ensure that foreign objects like dirt, weed, etc. do not enter the tube when the user uses the weeding tool.

In additional aspects, the blade may include a first blade portion that may include the sharp distal end, and a second blade portion. The tube may engulf the second blade portion and the user may “rest” the finger on the second blade portion when the user inserts the finger into the tube.

The weeding tool may further include a finger support structure that may be disposed at the tube proximal end. The finger support structure may provide support to the user finger when the user uses the weeding tool. The finger support structure may be curved, flexible and have a broad surface, so that the user may easily rest and move the finger on the finger support structure when the user uses the weeding tool and apply pressure to the weeding tool using force applied from the underside of the finger on which the device is used.

The present disclosure discloses a portable and convenient gardening implement that that facilitates soil manipulation and removal of plant roots or other plant matter in the soil while being convenient for users of different physiologies. For example, users with various finger dimensions may easily use the tool by inserting their fingers into the elongated tube and manipulating the weeding tool to remove unwanted plant matter from the ground. Moreover, by providing a curved portion that supports the underside of the finger, the user may apply force using the structure of the hand and base of the finger instead of relying on hand and finger strength to perform the gardening tasks. Accordingly, users with limited hand mobility or diminishing hand strength may perform tasks that would otherwise require stronger hands and fingers. The weeding tool is lightweight and not bulky, and hence easy to carry and use in smaller gardens or lawns.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

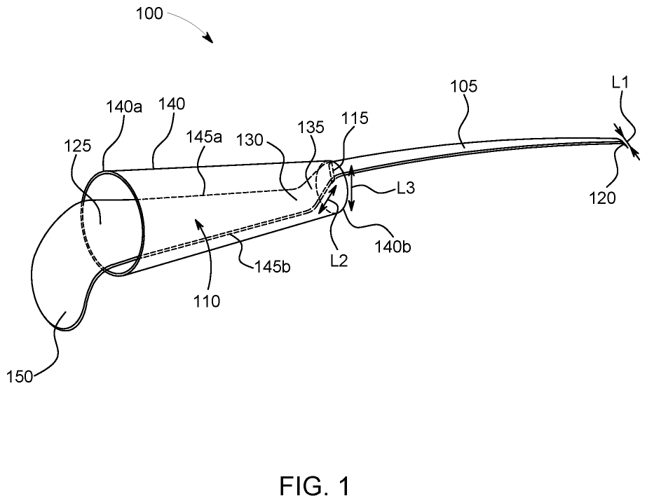

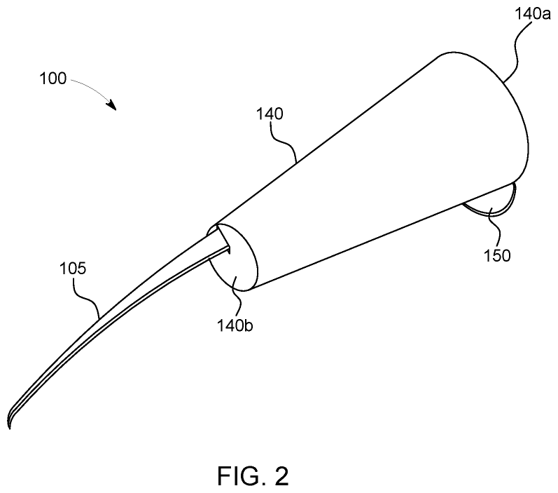

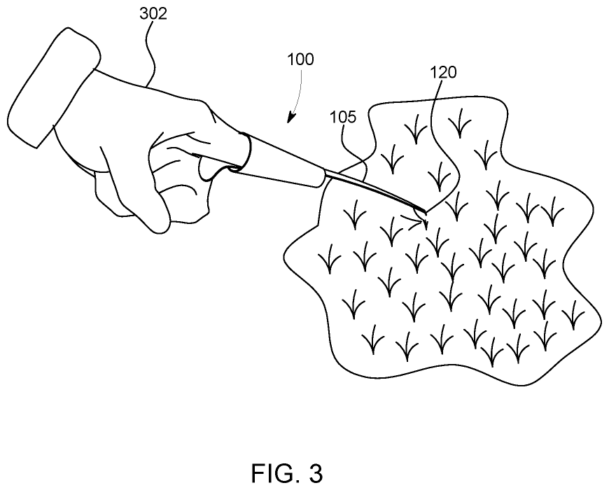

FIG. 1 depicts a backside isometric view of an example gardening tool 100 in accordance with the present disclosure. While describing FIG. 1, reference may be made to FIGS. 2 and 3.

The gardening tool 100 may be a finger weeding tool that may be worn by a user (not shown in FIG. 1) on the user's finger. The user may insert the finger into the weeding tool 100 and use the weeding tool 100 to remove unwanted plant matter from ground. For example, the user may use the weeding tool 100 to remove unwanted weed, wild grass, dandelions, crabgrass, etc. from user's lawn or garden.

The weeding tool 100 may include an elongated blade that may have a first blade portion 105 and a second blade portion 110. The first blade portion 105 and the second blade portion 110 may be made of metal such as aluminum, steel, iron, and/or the like. The first blade portion 105 and the second blade portion 110 may be made of same material or different materials. In some aspects, a first blade portion 105 length may be same as or equivalent to a second blade portion 110 length. In other aspects, the first blade portion 105 length may be less or more than the second blade portion 110 length. Further, a first blade portion 105 thickness may be same as or equivalent to a second blade portion 110 thickness.

The first blade portion 105 may have a tapered width such that a first blade portion width at a first blade portion proximal end 115 may be greater than the first blade portion width at a first blade portion distal end 120, as shown in FIG. 1. Further, the second blade portion 110 too may have a tapered width such that a second blade portion width at a second blade portion proximal end 125 may be greater than the second blade portion width at a second blade portion distal end 130. In some aspects, the second blade portion width at the second blade portion distal end 130 may be same as or equivalent to the first blade portion width at the first blade portion proximal end 115, which may be equivalent to a width of a human finger (e.g., in a range of 0.4 to 0.6 inches).

First blade portion opposing side edges along a first blade portion 105 length may be blunt and the first blade portion distal end 120 may be a sharp or a pointed end. The first blade portion distal end 120 may be tapered or curved/twisted “downwards” at a first predefined angle relative to a first blade portion longitudinal axis. In some aspects, the first predefined angle may be in a range of 10 to 30 degrees. Further, a length “L1” of the tapered or curved distal end portion may be in a range of 2 to 10% of the first blade portion 105 length.

FIGS. 1-4 show the distal end of the first blade portion 105 as a sharp point. It should be appreciated that, although depicted as a sharp point in FIGS. 1-4, the first blade portion 105 may include a narrow portion at the tip having a spoon shape, a narrowing blunt shape, a point, or a serrated cutting shape, among others.

Accordingly, in one or more embodiments, the distal end 120 may include a width dimension (width dimension not shown in FIG. 1) having a narrower width respective to the proximal end such that the first blade portion 105 includes a sharp or narrow end that may aid in inserting the first blade portion 105 into the soil.

In some aspects, the first blade portion 105 may be a flat blade portion or may have a flat surface. In other aspects, the first blade portion 105 may be slightly curved at a first blade portion 105 center portion (or may be arc-shaped), as shown in FIG. 1.

The first blade portion 105 and the second blade portion 110 may be attached to each other via a Z-shaped connector 135. Specifically, as shown in FIG. 1, the first blade portion proximal end 115 may be attached to the second blade portion distal end 130 via the Z-shaped connector 135. The Z-shaped connector 135 may be formed from the same material as the first blade portion 105 and the second blade portion 110. Further, the first blade portion 105, the second blade portion 110 and the Z-shaped connector 135 may form a unitary structure, as shown in FIG. 1. The unitary structure may be flexible or semi-flexible, such that the first blade portion 105 and/or the second blade portion 110 may be flexed relative to the Z-shaped connector 135.

A Z-shaped connector 135 width may be same as or equivalent to the second blade portion width at the second blade portion distal end 130 and the first blade portion width at the first blade portion proximal end 115, which may be equivalent to a human finger width, as described above.

A length “L2” of a Z-shaped connector 135 middle portion may be in a range of 0.75 to 1.5 inches. Further, the Z-shaped connector 135 middle portion may be slanted at a second predefined angle relative to a second blade portion longitudinal axis and the first blade portion longitudinal axis. The second predefined angle may range from 40 to 60 degrees. In other aspects, the Z-shaped connector 135 middle portion may be slanted steeper (not shown) relative to the first blade portion longitudinal axis as compared to the second blade portion longitudinal axis. For example, the Z-shaped connector 135 middle portion may be slanted at an angle of 75-90 degrees relative to the first blade portion longitudinal axis, and at an angle of 45-70 degrees relative to the second blade portion longitudinal axis. In additional aspects, a connection between the Z-shaped connector 135 and the second blade portion 110 may be curved, such that the connection may form a smooth finish surface.

A person ordinarily skilled in the art may appreciate from the view depicted in FIG. 1 and from the description above that the first blade portion 105 and the second blade portion 110 may be displaced vertically at a predefined distance “L3” from each other. The predefined distance L3 may be based on the length “L2” of the Z-shaped connector 135 middle portion and the second predefined angle.

The weeding tool 100 may further include an elongated tube 140 having a tube proximal end 140a and a tube distal end 140b. The tube 140 may be formed of molded plastic, silicon, aluminum, steel and/or the like, or a combination thereof. Further, the tube 140 may be flexible or semi-flexible.

As shown in FIG. 1, the tube 140 may engulf the second blade portion 110, and may have a tube 140 length that may be same as or equivalent to a second blade portion 110 length. In some aspects, the tube proximal end 140a may be attached to the second blade portion proximal end 125. In other aspects, a tube 140 interior surface may be attached to second blade portion opposing edges 145a, 145b, along a second blade portion 110 length. Further, the tube distal end 140b may be attached to the first blade portion proximal end 115.

In some aspects, the first blade portion proximal end 115 may be attached to a tube 140 first surface (e.g., a top interior surface) and the second blade portion proximal end 125 may be attached to a tube 140 second/opposing surface (e.g., a bottom interior surface), as shown in FIG. 1.

Further, the tube 140 may have a tapered shape (e.g., like a funnel) such that a tube distal end 140b diameter may be smaller than a tube proximal end 140a diameter, as shown in FIG. 1. In some aspects, the tube distal end 140b diameter may be 25-50% smaller than the tube proximal end 140a diameter. The tube distal end 140b diameter may be substantially same as or equivalent to the predefined distance “L3” described above. The tube 140 may have a shape (and corresponding diameters of the tube proximal end 140a and the tube distal end 140b) such that the user may easily insert the user finger into the tube 140 inner surface.

In some aspects, the tube proximal end 140a may be an open end through which the user may insert the user finger, and the tube distal end 140b may be a closed end. The closed end of the tube distal end 140b is shown in FIG. 2. Specifically, FIG. 2 depicts a front side isometric view of the weeding tool 100, in accordance with the present disclosure.

As shown in FIG. 2, the tube distal end 140b may be a closed end that may completely seal the tube distal end 140b (with only the first blade portion 105 protruding from the tube distal end 140b) such that no foreign object, e.g., dirt, may enter the tube 140 from the tube distal end 140b.

The weeding tool 100 may further include a finger support surface 150 that may be attached to the second blade portion proximal end 125. In some aspects, the finger support surface 150 may be attached to the second blade portion proximal end 125 such that the finger support surface 150 may be aligned at a third predefined angle relative to the second blade portion longitudinal axis. The third predefined angle may be in a range of 50 to 70 degrees.

In some aspects, the finger support surface 150 may be made from the same material as the first blade portion 105, the second blade portion 110 and the Z-shaped connector 135. Further, the first blade portion 105, the second blade portion 110, the Z-shaped connector 135 and the finger support surface 150 may form a single unitary structure, as shown in FIG. 1. In other aspects, one or more of the first blade portion 105, the second blade portion 110, the Z-shaped connector 135 and the finger support surface 150 may be formed of different materials.

The finger support surface 150 may provide support to the user's finger or the user may “rest” the finger on the finger support surface 150, when the user inserts the finger into the tube 140.

In operation, the user may insert the user finger (e.g., the index finger into the tube 140 through the tube proximal end 140a to use the weeding tool 100. FIG. 3 depicts an example embodiment of a user 302 using the weeding tool 100 in accordance with the present disclosure. As shown in FIG. 3, the user 302 may use the weeding tool 100 to remove unwanted plant matter from the ground. The user 302 may additionally insert the weeding tool 100 into the ground and may use the weeding tool 100 to remove roots that may be located inside the ground. The tapered width of the first blade portion 105 (as described above) may assist the user 302 to insert the first blade portion 105 into the ground. Further, the curved first blade portion distal end 120 may assist the user 302 to conveniently pluck weed or [symbol] from the ground.

In some aspects, the user may “rest” the finger on the second blade portion 110 when the user inserts the finger into the tube 140. Stated another way, the second blade portion 110 may provide cushion for the finger and may hence make the weeding tool 100 convenient for the user to use.

In some aspects, a tube 140 length may be in range of 60% to 70% of a user finger length, and a finger support surface 150 length may be in a range of 25% to 40% of the user finger length. In this manner, the user 302 may insert a substantial part of the finger into the tube 140 and the remaining part may rest on the finger support surface 150. The curved surface of the finger support surface 150 (e.g., the third predefined angle) may assist the user 302 to easily fold or move the user finger when the user 302 uses the weeding tool 100. The user may additionally use the finger support surface 150 to push the weeding tool 100 into the ground. For example, the user may push the finger support surface 150 by using the finger, which may cause the first blade portion distal end 120 to insert into the ground.

Further, the user 302 may insert the weeding tool 100 into the ground by pushing the Z-shaped connector 135 using a user fingertip portion (not shown). As described above, the Z-shaped connector 135 width may be equivalent to the human finger width, which may assist the user 302 to conveniently place the user fingertip portion on the Z-shaped connector 135 middle portion and “push” the weeding tool 100 into the ground by using force of the user fingertip portion. The second predefined angle of the Z-shaped connector 135 middle portion (relative to the second blade portion longitudinal axis and the first blade portion longitudinal axis) may further assist the user 302 to conveniently place the user fingertip portion on the Z-shaped connector 135 middle portion.

In addition, since the tube distal end 140b is a closed end, foreign objects like dirt, soil, weed, etc. do not enter the tube 140 when the user 302 uses the weeding tool 100, thus facilitating in keeping the user finger clean.

A person ordinarily skilled in the art may appreciate that since the tube 140 is made of flexible/semi-flexible material, the weeding tool 100 may be used by users of different physiologies. Further, the weeding tool 100 may be formed of lightweight material, such that the weeding tool 100 may be portable and may be easily carried by the users to remove weed/roots from smaller gardens/lawns.

The weeding tool 100 may further include a plurality of additional features/elements that is not shown in FIGS. 1, 2 and 3. For example, in some aspects, the first blade portion 105 may include a telescoping means using which the user 302 may adjust the first blade portion 105 length. Additionally, or alternatively, the tube 140 may include a telescoping means to adjust the tube 140 length. By using the telescoping means of the first blade portion 105 and/or the tube 140, weeding tool 100 dimensions may be adjusted so that users with different finger lengths or weeding requirements may use the weeding tool 100.

In further aspects, the first blade portion 105 may be retractable into the tube 140, such that the user 302 may “push” the first blade portion 105 into the tube 140 when the user 302 is not using the weeding tool 100. In this case, the first blade portion 105 may connect with the Z-shaped connector 135 via a plurality of rollers and a latching lock mechanism, so that the user may be easily lock, unlock, and slide the first blade portion 105 into/from the tube 140. In addition, the finger support surface 150 may be foldable, such that the user 302 may fold the finger support surface 150 “upwards” to cover the open-ended tube proximal end 140a, when the weeding tool 100 is not in use. In this case, the finger support surface 150 may connect with the second blade portion proximal end 125 via a folding and lock mechanism (e.g., a hinge and a latch) that may enable the user 302 to lock, unlock and rotate the finger support surface 150 upwards or downwards based on user requirements.

By retracting the first blade portion 105 into the tube 140 and by folding the finger support surface 150, the user 302 may make the weeding tool 100 compact and more convenient to carry when the weeding tool 100 is not in use.

In yet another aspect, the first blade portion 105 and/or the finger support surface 150 may be detachable from the weeding tool 100. In further aspect (not shown), the Z-shaped connector 135 and/or the second blade portion 110 may not there in the weeding tool 100. In this case, the first blade portion 105 may be attached to the tube distal end 140b and the finger support surface 150 may be attached to the tube proximal end 140a. The user 302 may insert the user finger into the tube 140 and may push the closed tube distal end 140b from inside to insert the weeding tool 100 into the ground.

In additional aspects, the first blade portion distal end 120 may include a fork with multiple tines, as opposed to a single tine as shown in FIG. 1, 2 or 3. In other aspects, the tine(s) may be removable/detachable, so that the user 302 may replace one type of an end (e.g., a single tine end) with another type (e.g., a fork with multiple tines).

In yet another aspect, the tube 140 may include an opening along the tube 140 length that may enable the user 102 to “open” the tube 140 from the tube proximal end 140a. The user 302 may insert the user finger into the tube 140 by opening the tube 140. The tube 140 may further include one or more flexible fasteners (e.g., flexible surface clamps) using which the user 302 may close or lock the opening when the user 102 inserts the finger. A person ordinarily skilled in the art may appreciate that by using the opening and the flexible fasteners, users with different finger dimensions may use the weeding tool 100 easily.

In additional aspects, the weeding tool 100 may include fastening means to fasten the tube proximal end 140a around the user finger, when the user 302 inserts the user finger into the tube 140. The fastening of the tube proximal end 140a around the user finger may ensure that foreign objects like dirt do not enter the tube 140 (and hence make the user finger unclean through the tube proximal end 140a.

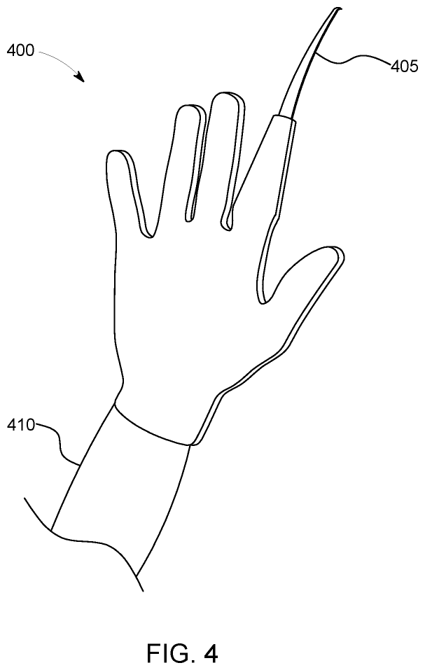

FIG. 4 depicts another example gardening tool 400 in accordance with the present disclosure. The tool 400 may be a hand glove, as shown in FIG. 4, in which a weeding tool 405 may be incorporated. The weeding tool 405 may be same as the weeding tool 100 and may be sewn to the tool 400 or may be an integrated part of the tool 400. In an one aspect, the tube 140 may be attached to a tool 400 interior surface. In another aspect, the tube 140 may be attached to a tool 400 exterior surface.

The tool 400 may be made of a flexible material that may make it convenient for a user 410 to use the tool 400. For example, the tool 400 may be made of synthetic leather, silicone, nitrile, polyvinyl chloride, and/or the like. The tool 400 may make it easier for the user 410 to grip the unwanted plant matter, when the user 410 removes the unwanted plant matter by using the weeding tool 405.

The user 410 may insert the tool 400 onto a user palm (not shown) and may use the weeding tool 405 to remove unwanted plant matter from the ground. In some aspects, the weeding tool 405 may be disposed at a user's index finger, as shown in FIG. 4. In other aspects (not shown) the weeding tool 405 may be disposed at another user finger, e.g., a ring finger, a middle finger, etc. In yet another aspect, more than one weeding tool may be disposed on the tool 400. For example, the tool 400 may include five weeding tools (one on each finger), so that the user 410 may use blades included in any of the five weeding tools to remove the unwanted plant matter from the ground.

In the embodiment shown in FIG. 4, the tool 400 may not include the finger support surface 150. Further, the tool 400 may or may not include the second blade portion 110. In the latter case, the weeding tool blade may be directly attached to the tube distal end 140b, as described above.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. An apparatus comprising:
an elongated blade comprising a first blade portion and a second blade portion, wherein:
a first blade portion distal end comprising a narrow portion, wherein the narrow portion comprises one or more of a blade width or a blade thickness having a smaller dimension respective to a blade width or a blade thickness at the first blade portion proximal end, and
a first blade portion proximal end is attached to a second blade portion distal end via a Z-shaped connector; and
an elongated tube configured to engulf the second blade portion, wherein:
the elongated tube comprises a tube distal end and a tube proximal end,
the tube distal end is attached to the first blade portion proximal end, and
the tube proximal end is attached to a second blade portion proximal end.

2. The apparatus of claim 1, wherein a tube distal end diameter is smaller than a tube proximal end diameter.

3. The apparatus of claim 1, wherein the tube distal end is a closed end, and the tube proximal end is an open end.

4. The apparatus of claim 3, wherein the tube proximal end is configured to receive a user finger.

5. The apparatus of claim 4, wherein a tube length is in a range of 60% to 70% of a user finger length.

6. The apparatus of claim 5, wherein the tube length is equivalent to a second blade portion length.

7. The apparatus of claim 4 further comprising a finger support surface attached to the second blade portion proximal end.

8. The apparatus of claim 7, wherein a finger support surface length is in a range of 25% to 40% of a user finger length.

9. The apparatus of claim 7, wherein the finger support surface is attached to the second blade portion proximal end at a first predefined angle relative to a second blade portion longitudinal axis.

10. The apparatus of claim 9, wherein the first predefined angle is in a range of 50 to 70 degrees.

11. The apparatus of claim 7, wherein the first blade portion, the second blade portion, the Z-shaped connector, and the finger support surface form a unitary structure.

12. The apparatus of claim 1, wherein the sharp end is twisted at a second predefined angle relative to a first blade portion longitudinal axis.

13. The apparatus of claim 12, wherein the second predefined angle is in a range of 10 to 30 degrees.

14. The apparatus of claim 1, wherein the gardening tool is part of a glove.

15. An apparatus comprising:
an elongated blade comprising a first blade portion and a second blade portion, wherein:
a first blade portion distal end is a sharp end, and
a first blade portion proximal end is attached to a second blade portion distal end via a Z-shaped connector;
an elongated tube configured to engulf the second blade portion, wherein:
the elongated tube comprises a tube distal end and a tube proximal end,
the tube distal end is attached to the first blade portion proximal end,
the tube proximal end is attached to a second blade portion proximal end, and
the tube proximal end is configured to receive a user finger; and
a finger support surface attached to the second blade portion proximal end.

16. The apparatus of claim 15, wherein the first blade portion, the second blade portion, the Z-shaped connector and the finger support surface form a unitary structure.

17. The apparatus of claim 15, wherein a tube distal end diameter is smaller than a tube proximal end diameter.

18. The apparatus of claim 15, wherein the tube distal end is a closed end and the tube proximal end is an open end.

19. The apparatus of claim 15, wherein the gardening tool is part of a glove.

20. An apparatus comprising:
an elongated blade comprising a first blade portion and a second blade portion, wherein:
a first blade portion distal side is a sharp end, and
a first blade portion proximal end is attached to a second blade portion distal end via a Z-shaped connector; and
an elongated tube configured to engulf the second blade portion, wherein:
the elongated tube comprises a tube distal end and a tube proximal end,
the tube distal end is attached to the first blade portion proximal end,
the tube proximal end is attached to a second blade portion proximal end, and
the tube distal end is a closed end, and the tube proximal end is an open end.
